(19) United States
(12) Patent Application Publication
(10) Pub. No.: US 2018/0020410 A1
(43) Pub. Date: Jan. 18, 2018

(54) POWER SAVING FOR WIRELESS LOCAL AREA NETWORK

(71) Applicant: NEUROMEKA, Seoul (KR)

(72) Inventor: Jong Hoon PARK, Namyangju (KR)

(21) Appl. No.: 15/652,723

(22) Filed: Jul. 18, 2017

(30) Foreign Application Priority Data
Jul. 18, 2016 (KR) 10-2016-0090666
Aug. 2, 2016 (KR) 10-2016-0098291
Aug. 3, 2016 (KR) 10-2016-0098812
Aug. 11, 2016 (KR) 10-2016-0102160

(51) Int. Cl. H04W 52/02; H04L 29/08; H04W 56/00; H04W 84/12

(52) U.S. Cl. CPC H04W 52/0235; H04W 56/001; H04L 67/22; H04W 84/12

(57) ABSTRACT

A method for power saving in a wireless local area network and a device using the same are provide. The device wakes up at a start of a wakeup time and receives a wakeup physical layer protocol data unit (PPDU) during the wakeup time. The device updates a timing synchronization function (TSF) timer in accordance with a value in the wakeup PPDU.

### CROSS-REFERENCE TO RELATED APPLICATIONS

This application claims the benefit of priority of Korean Patent Application Nos. 10-2016-0090666 filed on Jul. 18, 2016, 10-2016-0098291 filed on Aug. 2, 2016, 10-2016-0098812 filed on Aug. 3, 2016 and 10-2016-0102160 filed on Aug. 11, 2016, all of which are incorporated by reference in their entirety herein.

### BACKGROUND OF THE INVENTION

### Field of the Invention

The present invention relates to wireless communication and, more particularly, to a method and device for power saving in a wireless communication system.

### Related Art

Institute of Electrical and Electronics Engineers (IEEE) 802.11 based wireless local area networks (WLANs), the most popular and successful indoor wireless solutions, have evolved as a key enabling technology to cover medium to large scale enterprises, public area hot-spots, apartment complexes, and are ubiquitous in the modern world.

As more WLAN chips are embedded into battery powered mobile devices, power consumption inevitably becomes a bottleneck to its wide deployment. The average power consumption for a typical WLAN device, employing the power saving technique specified in the IEEE 802.11 standard, is significantly higher than a normal cellular phone. This further implies that a cellular phone with current battery capacity will be drained in substantially less time if a WLAN chip is embedded.

Accordingly, there is a need for an improved protocol to minimize a power consumption in WLAN.

### SUMMARY OF THE INVENTION

The present invention provides a method and device for power saving in a wireless local area network.

In an aspect, a method for power saving in a wireless local area network is provided. The method performed by a station includes waking up at a start of a wakeup time, during the wakeup time, receiving a wakeup physical layer protocol data unit (PPDU), the wakeup PPDU including a timing synchronization function (TSF) field indicating a value of a TSF timer, and updating the TSF timer based on the TSF field.

The wakeup PPDU may include a legacy-Short Training field (L-STF), a legacy-Long Training field (L-LTF) 320, a legacy-SIGNAL field (L-SIG), a wakeup physical (PHY) header and wakeup information, and

The wakeup PHY header may include a sync field and a receiver ID field, the sync field indicating a start of the wakeup PHY header, the receiver ID field indicating the station to receive the wakeup PPDU.

In another aspect, a device for power saving in a wireless local area network includes a transceiver configured to receive and transmit radio signals, and a processor coupled with the transceiver. The processor is configured to wake up at a start of a wakeup time, during the wakeup time, control the transceiver to receive a wakeup physical layer protocol data unit (PPDU), the wakeup PPDU including a timing synchronization function (TSF) field indicating a value of a TSF timer, and update the TSF timer based on the TSF field.

### BRIEF DESCRIPTION OF THE DRAWINGS

FIG. 1 shows various IFSs.

FIG. 2 shows a system according to an embodiment of the invention.

FIG. 3 shows a wakeup PPDU format according to an embodiment of the invention.

FIG. 4 shows wakeup PPDU formats according to another embodiment of the invention.

FIG. 5 shows an example of protection mechanism using a wakeup PPDU.

FIG. 6 shows a protection mechanism according to an embodiment of the invention.

FIG. 7 shows an operation of a STA according to an embodiment of the invention.

FIG. 8 shows a format of a channel switch announcement element.

FIG. 9 shows a format of LP-WUR channel switch element.

FIG. 10 shows a recover procedure using the wakeup PPDU.

FIG. 11 shows a format of a wakeup channel switch frame.

FIG. 12 shows a target wake time.

FIG. 13 shows a format of a wakeup sync frame.

FIG. 14 shows a block diagram of a device to implement embodiments of the present invention.

### DESCRIPTION OF EXEMPLARY EMBODIMENTS

The proposed wireless local area network (WLAN) system may operate at a band of 2.4 GHz and/or 5 GHz. For clarity, a system complying with the Institute of Electrical and Electronics Engineers (IEEE) 802.11 a/g standard is referred to as a non-High Throughput (non-HT) system, a system complying with the IEEE 802.11n standard is referred to as a High Throughput (HT) system, a system complying with IEEE 802.11ac standard is referred to as a Very High Throughput (VHT) system, and a system complying with IEEE 802.11ax standard is referred to as a High Efficiency (HE) system.

A WLAN system may include a station (STA) and an Access Point (AP). Unless a function of a STA is additionally distinguished from a function of an AP, the STA may include a non-AP STA and/or the AP. When it is described as an STA-to-AP communication, the STA may be expressed as the non-AP STA, and may correspond to communication between the non-AP STA and the AP. When it is described as STA-to-STA communication or when a function of the AP is not additionally required, the STA may be the non-AP STA or the AP.

A Physical layer Protocol Data unit (PPDU) is a data unit for data transmission. A basic service set (BSS) may include a set of STAs that have successfully synchronized with an AP. A basic service set identifier (BSSID) is a 48 bits identifier of a corresponding BSS. An overlapping basic service set (OBSS) may be a BSS operating on the same channel as the STA's BSS. The OBSS is one example of different BSS with the STA's BSS.

Enhanced Distributed Channel Access (EDCA) channel access protocol is derived from the Distributed Coordination Function (DCF) procedures by adding four independent enhanced distributed channel access functions (EDCAFs) to provide differentiated priorities to transmitted traffic, through the use of four different access categories (ACs).

Each EDCAF shall maintain a backoff timer, which has a value measured in backoff slots. When the backoff procedure is invoked, the backoff timer is set to an integer value chosen randomly with a uniform distribution taking values in the range [0,CW[AC]] inclusive. The duration AIFS[AC] is a duration derived from the value AIFSN[AC] by the relation: AIFS[AC]=AIFSN[AC]×aSlotTime+aSIFSTime.

In an infrastructure BSS, AIFSN[AC] is advertised by an AP in the EDCA Parameter Set element in Beacon and Probe Response frames transmitted by the AP. The value of AIFSN[AC] shall be greater than or equal to 2 for non-AP STAs. The value of AIFSN[AC] shall be greater than or equal to 1 for APs. An EDCA transmission opportunity (TXOP) which is an interval of time during which a STA has the right to initiate frame exchange sequences onto a wireless medium is granted to an EDCAF when the EDCAF determines that it shall initiate the transmission of a frame exchange sequence.

Physical and virtual Carrier sense (CS) functions are used to determine the state of the wireless medium. When either function indicates a busy medium, the medium shall be considered busy; otherwise, it shall be considered idle.

A physical CS mechanism shall be provided by the physical layer (PHY). A virtual CS mechanism shall be provided by the Medium Access Control (MAC) layer. This mechanism is referred to as the network allocation vector (NAV). The NAV maintains a prediction of future traffic on the medium based on duration information that is announced in Request-to-Send (RTS)/Clear-to-Send (CTS) frames prior to the actual exchange of data. The duration information is also available in the MAC headers of all frames sent during the contention period other than PS-Poll frames.

The CS mechanism combines the NAV state and the STA's transmitter status with physical CS to determine the busy/idle state of the medium. The NAV may be thought of as a counter, which counts down to 0 at a uniform rate. When the counter is 0, the virtual CS indication is that the medium is idle; when the counter is nonzero, the indication is busy. The medium shall be determined to be busy when the STA is transmitting.

A STA that receives at least one valid frame in a Physical layer Service Data Unit (PSDU) can update its NAV with the information from any valid Duration field in the PSDU. When the received frame's receiver address (RA) is equal to the STA's own MAC address, the STA shall not update its NAV. For all other received frames the STA shall update its NAV when the received Duration is greater than the STA's current NAV value. Upon receipt of a PS-Poll frame, a STA shall update its NAV settings as appropriate under the data rate selection rules using a duration value equal to the time, in microseconds, required to transmit one Ack frame plus one Short Interframe Space (SIFS), but only when the new NAV value is greater than the current NAV value. If the calculated duration includes a fractional microsecond, that value is rounded up to the next higher integer. Various additional conditions may set or reset the NAV. When the NAV is reset, a PHY-CCARESET.request primitive shall be issued. This NAV update operation is performed when the PHY-RXEND.indication primitive is received. The PHY-RXEND.indication primitive is an indication by the PHY to the local MAC entity that the PSDU currently being received is complete.

The PHY-RXEND.indication primitive is generated by the PHY for the local MAC entity to indicate that the receive state machine has completed a reception with or without errors. When a Signal Extension is present, the primitive is generated at the end of the Signal Extension. A RXERROR parameter of The PHY-RXEND.indication primitive provides error conditions. When the RXERROR parameter is set to ‘NoError’, no error occurred during the receive process in the PHY. When the RXERROR parameter is set to ‘Filtered’, during the reception of the PPDU, the PPDU was filtered out due to a condition set in the PHYCONFIG_VECTOR. In the case of an RXERROR value of NoError, the MAC uses the PHY-RXEND.indication primitive as reference for channel access timing.

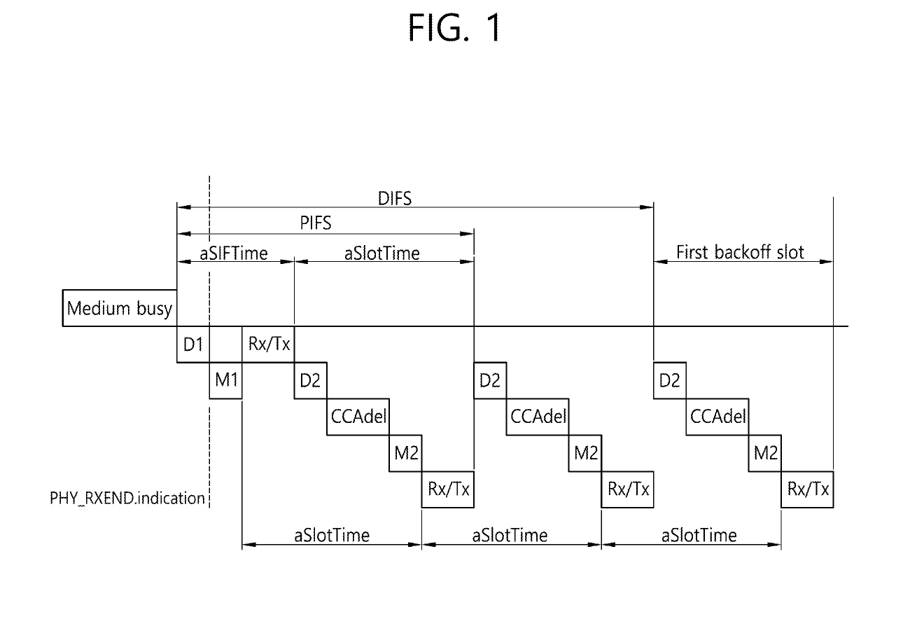

FIG. 1 shows various IFSs.

The time interval between frames is called an Inter-Frame Spacing (IFS). A point coordination function (PCF) interframe space (PIFS) is defined as PIFS=aSIFSTime+aSlotTime, and a distributed interframe space (DIFS) is defined as DIFS=aSIFSTime+2×aSlotTime, where aSIFSTime=aRxPHYDelay+aMACProcessingDelay+aRxTxTurnaroundTime, aSlotTime=aCCATime+aMACProcessingDelay+aRxTxTurnaroundTime+aAirPropagationTime.

A DCF uses extended interframe space (EIFS) before transmission, when it determines that the medium is idle following reception of a frame for which the PHY-RXEND.indication primitive contained an error or a frame for which the FCS value was not correct. Similarly, a STA's EDCA mechanism under HCF shall use the EIFS—DIFS+AIFS[AC] interval. The EIFS or EIFS—DIFS+AIFS[AC] interval shall begin following indication by the PHY that the medium is idle after detection of the erroneous frame, without regard to the virtual CS mechanism. The STA shall not begin a transmission until the expiration of the later of the NAV and EIFS or EIFS−DIFS+AIFS[AC]. The EIFS and EIFS−DIFS+AIFS[AC] are defined to provide enough time for another STA to acknowledge what was, to this STA, an incorrectly received frame before this STA commences transmission. Reception of an error-free frame during the EIFS or EIFS−DIFS+AIFS[AC] resynchronizes the STA to the actual busy/idle state of the medium, so the EIFS or EIFS−DIFS+AIFS[AC] is terminated and medium access (using DIFS or AIFS as appropriate and, if necessary, backoff) continues following reception of that frame. At the expiration or termination of the EIFS or EIFS−DIFS+AIFS[AC], the STA reverts to the NAV and physical CS to control access to the medium.

When dot11DynamicEIFSActivated is false or not defined, the EIFS is derived from the SIFS and the DIFS and the length of time it takes to transmit an Ack frame at the lowest PHY mandatory rate by the following equation: EIFS=aSIFSTime+AckTxTime+DIFS, where AckTxTime is the time expressed in microseconds required to transmit an Ack frame, including preamble, PHY header and any additional PHY dependent information, at the lowest PHY mandatory rate.

When dot11DynamicEIFSActivated is true, EIFS is based on an estimated duration of the PPDU that is the possible response to the PPDU that causes the EIFS. When dot11DynamicEIFSActivated is true, if the PPDU that causes the EIFS does not contain a single MPDU with a length equal to 14 or 32 octets, then EIFS is determined as the following equation: EIFS=aSIFSTime+EstimatedAckTxTime+DIFS, where EstimatedAckTxTime is based on an estimated duration of the PPDU that is the possible response to the PPDU that causes the EIFS.

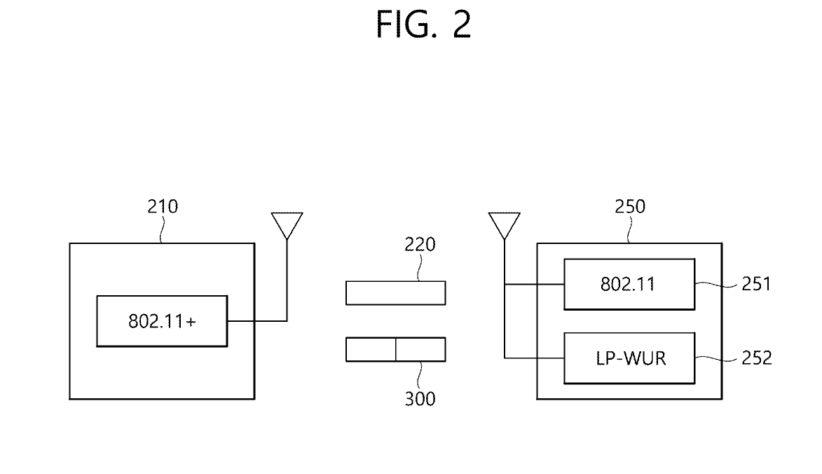

FIG. 2 shows a system according to an embodiment of the invention.

In order to reduce power consumption, a Low Power (LP)-Wakeup Radio (WUR) is proposed. A transmitter 210 may sends a normal PPDU 220 or a wakeup PPDU 300. The normal PPDU 220 may include non-HT PPDU, HT PPDU, VHT PPDU and/or HE PPDU.

A receiver 250 may include an 802.11 module 251 and an LP-WUR module 252. The 802.11 module 251 is a first radio module to receive or transmit a normal PPDU in accordance with IEEE 802.11 standards, and the LP-WUR module 252 is a second radio module to receive or transmit a wakeup PPDU. The transmitter 210 may also have an 802.11 module and an LP-WUR module.

The 802.11 module 251 and the LP-WUR module 252 are operated in a power save mode. ‘turn-on’ means that a radio module transitions from a sleep state to a wakeup state. ‘turn-off’ means that a radio module transitions from a wakeup state to a sleep state. The receiver 250 may turn-on the LP-WUR module 252 before receiving the wakeup PPDU 300.

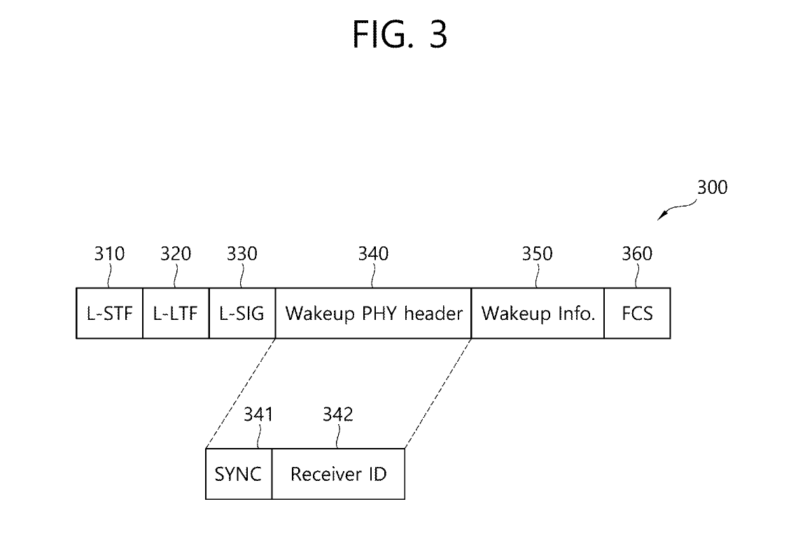

FIG. 3 shows a wakeup PPDU format according to an embodiment of the invention.

A wakeup PPDU 300 may include a legacy-Short Training field (L-STF) 310, a legacy-Long Training field (L-LTF) 320, a legacy-SIGNAL field (L-SIG) 330, a wakeup PHY header 340, wakeup information 350 and a frame check sequence (FCS) 360. A wakeup PSDU may include the wakeup PHY header 340, the wakeup information 350 and the FCS 360

L-STF 310, L-LTF 320 and L-SIG 330 are used to protect legacy STAs. The L-SIG 330 is used to communicate rate and length information. The L-SIG 330 may include a LENGTH field and a RATE field. The RATE field may be set to a predefined value. The RATE field may be set to the value representing 6 Mb/s in the 20 MHz channel. The LENGTH field may be set to the value given by the following equation:

$$LENGTH = ⌈ \frac{TXTIME - 20}{4} ⌉ \times 3 - 3 \qquad [ Equation 1 ]$$

where TXTIME indicates a length of the wakeup PPDU in time.

The FCS 360 contains cyclic redundancy check (CRC) bits that are calculated over the wakeup PHY header 340 and the wakeup information 350.

The wakeup PHY header 340 indicates a destination STA of the wakeup PPDU 300. The wakeup PHY header 340 may include a SYNC field 341 and a receiver ID field 342.

The SYNC field 341 indicates a start of the wakeup PHY header 340. The SYNC field 341 may be set to a predefined value.

The SYNC field 341 may be defined as a sequence staring with K consecutive zeros. K is an integer. K consecutive zeros may represent K consecutive idle symbols. The wakeup PPDU may include K consecutive idle symbols after L-SIG. The duration of the SYNC field 341 does not exceed an IFS (i.e. PIFS or 25 us) to prevent a channel access by other STAs. If a symbol duration is 4 us, K is not greater than 7 and may range from 1 to 6. Considering air propagation delay, it is sufficient that K ranges from 1 to 5. The duration of the SYNC field 341 my exceed SIFS (i.e. 16 us) to prevent an erroneous detection of the SYNC field 341 during a frame exchange. This means that K is greater than 4. To satisfy two conditions, K may be 5 or 6. When K is set to 5, there are 5 consecutive OFDM symbols after L-SIG. The LP-WUE module 252 starts to decode the receiver ID field 342 when 20 us of idle medium is detected after L-SIG.

The receiver ID field 342 indicates a destination STA of the wakeup PPDU 300. The receiver ID field 342 may include an ID delimiter subfield, a group subfield and an address subfield.

The ID delimiter subfield is used to discriminate the SYNC field 341 and the receiver ID field 342. The ID delimiter subfield may be set to a specific value (i.e. one). When the STA detects that the ID delimiter subfield does not set to the specific value, the STA considers the received wakeup PPDU is invalid.

When the group subfield indicates a single destination, the address subfield includes an address of the destination STA. When the group subfield indicates a group destination, the address subfield includes at least one addresses of the group of destination STAs.

The wakeup information 350 includes various kinds of information according to the type of the wakeup PPDU 300 and may be omitted.

When the wakeup PPDU 300 is used by an AP to assist an unassociated STA, the wakeup information 350 may include a Compressed SSID field, an Operating Class field, and a Channel field. The Operating Class field indicates a frequency band operated by the AP and the Channel field indicates a channel operated by the AP. The Compressed SSID field includes a part of service set identifier (SSID) of the AP and may have 32 bits. When the wakeup PPDU 300 is used by the AP to assist an unassociated STA, the group subfield of the receiver ID field 342 may indicate a group destination.

The 802.11 module 251 and the LP-WUR module 252 use different frequency bands. For example, the 802.11 module 251 operates in 5 GHz band but the LP-WUR module 252 operates in 2.4 GHz band. When the receiver 250 receives a wakeup PPDU via the LP-WUR module 252, the receiver 250 checks SSID of the AP. Then, the receiver 250 scans a frequency band of the AP via the 802.11 module 251.

When the wakeup PPDU 300 is used by an AP to assist an associated STA, the wakeup information 350 may include a BSSID of the AP. The group subfield of the receiver ID field 342 may indicate a single destination.

A band identifier indicating a frequency band in which the 802.11 module 251 operates can be included in the wakeup PHY header 340 or the wakeup information 350. The band identifier has at least two bits. It is assumed that an AP includes three 802.11 modules which supports 2.4 GHz, 5 GHz and 60 GHz.

For an example, the band identifier may be set to a first value (i.e. zero) to indicate that the wakeup PPDU 300 is associated with a 802.11 module of 2.4 GHz. The band identifier may be set to a second value (i.e. one) to indicate that the wakeup PPDU 300 is associated with a 802.11 module of 5 GHz. The band identifier may be set to a third value (i.e. two) to indicate that the wakeup PPDU 300 is associated with an 802.11 module of 60 GHz.

For another example, the band identifier may be used to wake up a STAs which operates in a specific band. The band identifier may be set to a first value (i.e. zero) when the AP wants to wake up all STAs which operates in 2.4 GHz. The band identifier may be set to a second value (i.e. one) when the AP wants to wake up all STAs which operates in 5 GHz. The band identifier may be set to a third value (i.e. two) when the AP wants to wake up all STAs which operates in 60 GHz. The band identifier may be set to a fourth value (i.e. three) when the AP wants to wake up all STAs which operates in sub-1 GHz. The band identifier may be set to a fifth value (i.e. four) when the AP wants to wake up all STAs which operates in all bands.

When an AP operated in a Dynamic Frequency Selection (DFS) channel of 5 GHz band and detects a radio signal corresponding to a primary user of the DFS channel, the AP switches its operating channel to another channel. The wakeup PPDU 300 may carry a wakeup management frame to instruct STAs turn on 802.11 modules and to request a reception of a beacon frame.

A check beacon field can be included in the wakeup PHY header 340 or the wakeup information 350. The check beacon field indicates an AP operating configuration version of the 802.11 module. The AP which will send a wakeup management frame keep a value of the check beacon field. When contents in a beacon frame is updated, the value of the check beacon field may be changed. For example, when the beacon frame includes a channel switch announcement field to advertise a channel switch, the value of the check beacon field may be increased by one.

When a STA receives a wakeup management frame, the STA checks whether the check beacon field is updated. When a stored value is different frame the value of the current check beacon field, the STA turn on 802.11 module and receives an updated beacon frame.

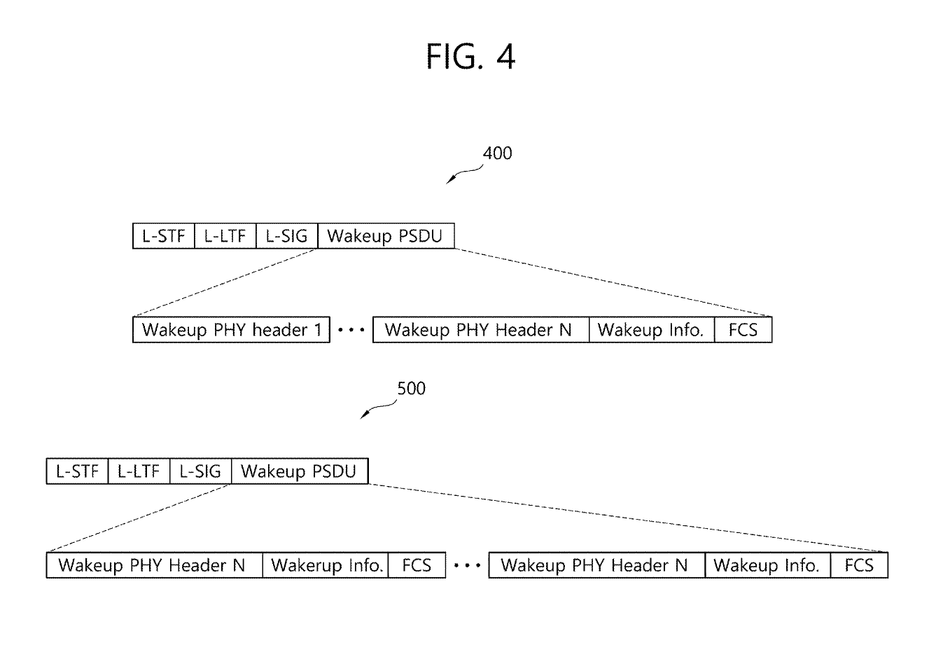

FIG. 4 shows wakeup PPDU formats according to another embodiment of the invention.

A wakeup PPDU 400 includes N wakeup PHY headers for N destination STAs. Each wakeup PDY header may indicates a corresponding destination STA.

A wakeup PPDU 500 includes N wakeup PHY headers for N destination STAs. Each wakeup PDY header may indicates a corresponding destination STA and is associated with corresponding wakeup information.

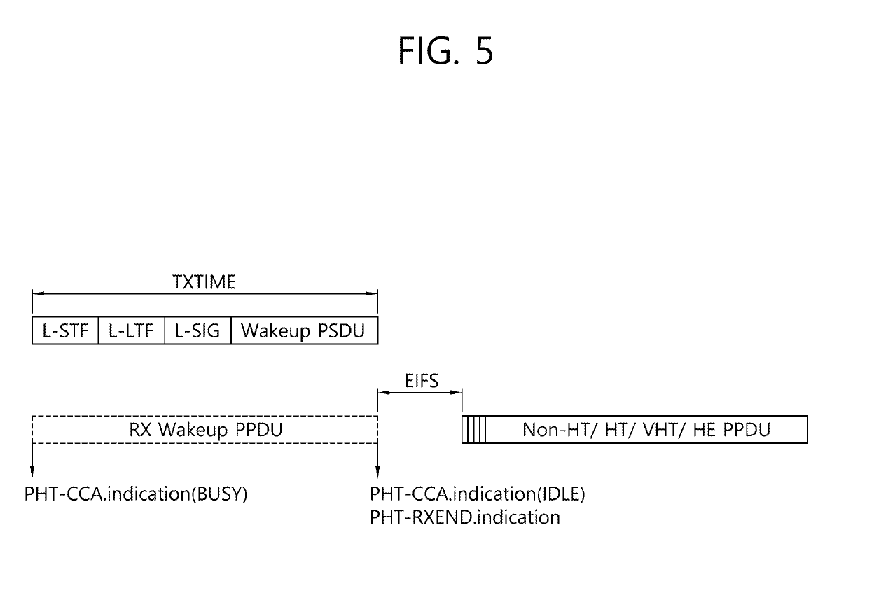

FIG. 5 shows an example of protection mechanism using a wakeup PPDU.

A LENGTH field of L-SIG in a wakeup PPDU 300 may be set to as Equation 1. When a PHY of a receiving STA receives the wakeup PPDU 300, the PHY of the receiving STA reports a BUSY to a MAC using a PHY-CCA.indication primitive during a TXTIME of the wakeup PPDU 300. The receiving STA does not access the channel during the TXTIME of the wakeup PPDU 300. When the receiving STA detects a termination of the wakeup PPDU 300 using a PHY-RXEND.indication primitive, the PHY of the receiving STA reports a IDLE to the MAC using a PHY-CCA.indication primitive.

If the receiving STA is a legacy STA that cannot decode a wakeup PSDU in the wakeup PPDU 300, the receiving STA has to wait for EIFS before starting a channel access. Since the wakeup PPDU does not trigger a transmission of a response frame, it may cause protocol overhead for the receiving STA to wait for EIFS that is longer than DIFS and SIFS.

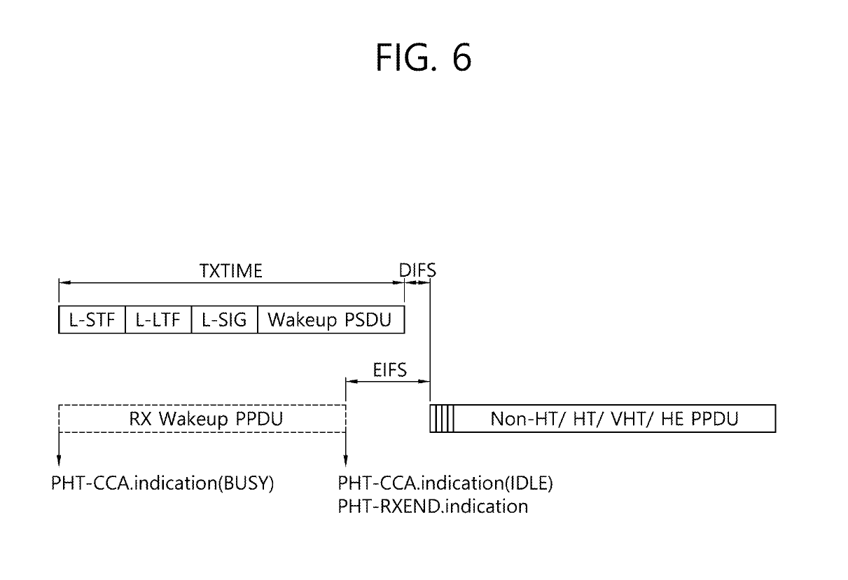

FIG. 6 shows a protection mechanism according to an embodiment of the invention.

A LENGTH field of L-SIG in a wakeup PPDU 300 may be set to the value given by the following equation:

$$LENGTH = ⌈ \frac{TXTIME - 20 - P 1 - P 2}{4} ⌉ \times 3 - 3 \qquad [ Equation 2 ]$$

where P1 denotes a first parameter and P2 denotes a second parameter. Values of P1 and P2 are predefined. More specifically, P1 may be set as aSIFSTime that is the time that the MAC and PHY require in order to receive the last symbol of a frame on the wireless medium, process the frame, and respond with the first symbol on the earliest possible response frame of the earliest possible response frame. P2 may be set as AckTxTime that is the time expressed in microseconds required to transmit an Ack frame. AckTxTime may be set to 44 microseconds (us) and aSIFSTime may be set to 10 us at 2.4 GHz or 16 us at 5 GHz.

When a legacy STA receives the wakeup PPDU 300, the legacy STA does not access the channel during the time indicated by the LENGTH field. The transmission of the wakeup PPDU 300 can be protected since the legacy STA waits for EIFS. As a result, the legacy STA can access the channel after DIFS (or AIFS) from the end of the wakeup PPDU 300.

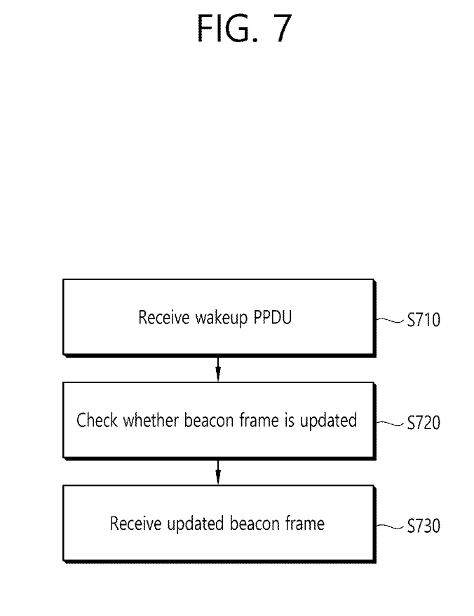

FIG. 7 shows an operation of a STA according to an embodiment of the invention.

In step S710, a STA receives a wakeup PPDU from an AP. The wakeup PPDU carries a wakeup management frame. The wakeup PPDU includes a check beacon field that indicates an AP's operating configuration version.

In step S720, the STA checks whether a beacon frame is updated. When a stored value is different frame the value of the current check beacon field in the wakeup PPDU, the STA confirms that the beacon frame is updated.

In step S730, the STA wakes up its' 802.11 module and begins to receive the updated beacon frame from the AP when the STA confirms that the beacon frame is updated.

The AP can update the value of the check beacon field when the beacon frame to be sent includes a channel switch announcement element.

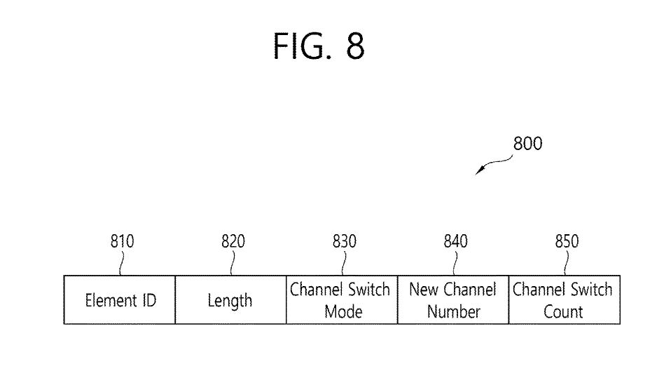

FIG. 8 shows a format of a channel switch announcement element.

A channel switch announcement element 800 is used by an AP to advertise when it is changing to a new channel and the channel number of the new channel.

An element ID 810 field indicates the channel switch announcement element 800. A length field 820 indicates a length of the channel switch announcement element 800. A channel switch mode field 830 indicates any restrictions on transmission until a channel switch. A new channel number field 840 is set to the number of the channel to which the STA is moving. A channel switch count field 850 may be set to the time until the AP sending the channel switch announcement element 800 switches to the new channel. The channel switch count field 850 may be set to zero to indicate that the switch occurs at any time after the frame containing the element is transmitted.

The STA that receives the channel switch announcement element 800 switch its channel to the new channel at the time indicated by the channel switch announcement element 800. If the LP-WUR module is operating in same channel with the 802.11 module, the channel of the LP-WUR module may be switched to the new channel indicated by the channel switch announcement element 800.

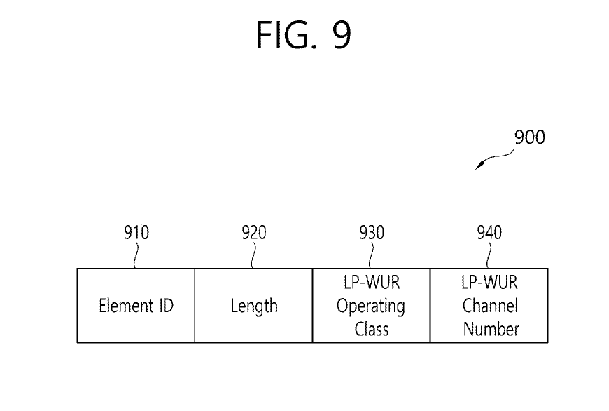

FIG. 9 shows a format of LP-WUR channel switch element.

When an AP wants that an LP-WUR module and an 802.11 module are operated in different channels, a LP-WUR channel switch element 900 is included in the beacon frame.

An element ID 910 field indicates the LP-WUR channel switch element 900. A length field 920 indicates a length of the LP-WUR channel switch element 900. A LP-WUR operating class field 930 indicates a frequency band in which the LP-WUR module is operated. A LP-WUR channel number field 940 indicates a channel to which the LP-WUR module is switched.

If a beacon frame includes both the channel switch announcement element 800 and the LP-WUR channel switch element 900, the STA switches to a new channel of the 802.11 module and switches to a new channel of the LP-WUR module.

After the 802.11 module is turned on based on the check beacon field, the 802.11 module is not turned off until the STA receives the updated beacon frame. When the STA receives the updated beacon frame, the STA updates the stored value with the new check beacon field and may turn off the 802.11 module.

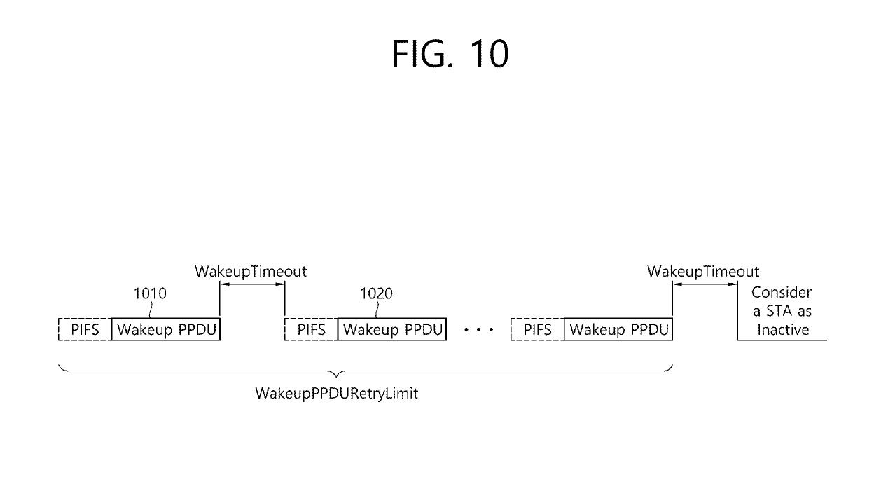

FIG. 10 shows a recover procedure using the wakeup PPDU.

An AP may send a wakeup PPDU 1010 without performing a backoff after determining the wireless medium is idle for one PIFS. A STA that receives the wakeup PPDU 1010, the STA may send a trigger frame to enable a service period and to keep a connectivity after turning on 802.11 module. The trigger frame may include PS-Poll frame or QoS Null frame.

If the AP does not receive any trigger frame from the STA during a WakeupTimeout, the AP may retransmit the wakeup PPDU 1020. A retry count may be increment whenever the wakeup PPDU is retransmitted. The retry count may be rest when a trigger frame is received. When the retry count reaches a WakeupPPDURetryLimit, the AP may consider that the STA is inactive, discard all buffered data for the STA and delete all system information related to the STA.

An AP may instruct a STA a maximum idle period by using an BSS Max Idle Period element. The BSS Max Idle Period element contains the time period a non-AP STA can refrain from transmitting frames to the AP before the AP disassociates the STA due to inactivity. The BSS Max Idle Period element includes a Max Idle Period field and an Idle Options field. The Max Idle Period field indicates the time period during which a STA can refrain from transmitting frames to its associated AP without being disassociated. The Idle Options field indicates the options associated with the BSS Idle capability. A non-AP STA is considered inactive if the AP has not received a frame (i.e. a Data frame, PS-Poll frame, or Management frame) of a frame exchange sequence initiated by the STA for a time period greater than or equal to the time specified by the Max Idle Period field.

If the Idle Options field requires security protocol protected keepalive frames, then the AP may disassociate the STA if no protected frames are received from the STA for a period indicated by the Max Idle Period field of the BSS Max Idle Period element. If the Idle Options field allows unprotected or protected keepalive frames, then the AP may disassociate the STA if no protected or unprotected frames are received from the STA for a duration indicated by the Max Idle Period field of the BSS Max Idle Period element.

In an embodiment of the invention, when the AP supports both the Wakeup PPDU and the BSS Max Idle Period element, the AP may disassociate the STA if the STA does not send any trigger frame as a response to the wakeup PPDU even though the STA sends a frame within the time specified by the Max Idle Period field.

In an embodiment of the invention, when the AP supports both the Wakeup PPDU and the BSS Max Idle Period element, the AP may not disassociate the STA if the STA sends any trigger frame as a response to the wakeup PPDU even though the STA does not send a frame within the time specified by the Max Idle Period field. This means that the AP does not consider that the STA is inactive when the STA sends any trigger frame as a response to the wakeup PPDU.

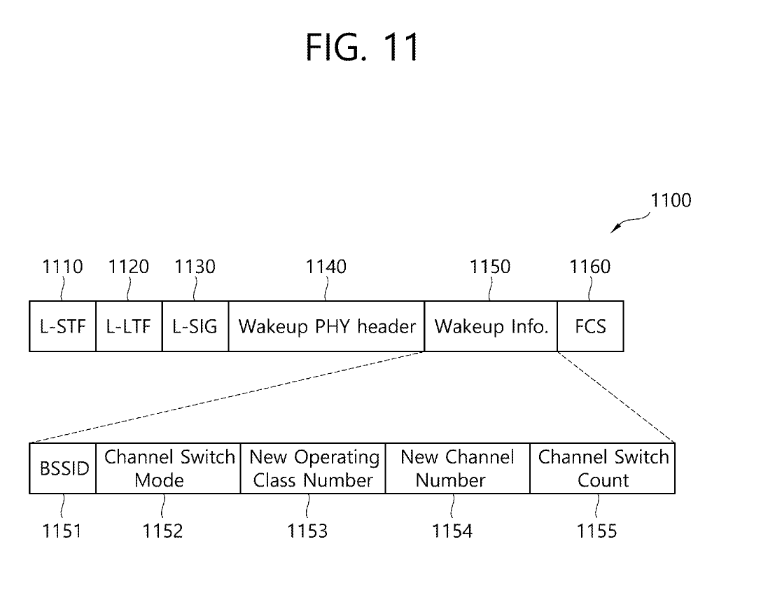

FIG. 11 shows a format of a wakeup channel switch frame. A wakeup channel switch frame 1100 is used to advertise a channel switch of a LP-WUR module of an AP when the AP detects a radar signal of a primary user in a DFS channel.

L-STF 1110, L-LTF 1120, L-SIG 1130, a wakeup PHY header 1140 and FCS 1160 are described in L-STF 310, L-LTF 320, L-SIG 330 and the a wakeup PHY header 340 and the FCS 360 of FIG. 3.

Wakeup information 1150 may include a BSSID field 1151, a Channel Switch Mode field 1152, a New Operating Class Number field 1153, a New Channel Number field 1154, a Channel Switch Count field 1155.

The BSSID field 1151 indicates a MAC address of the AP transmitting the Wakeup Channel Switch frame 1100.

The Channel Switch Mode field 1152 indicates any restrictions on transmission until a channel switch. The AP may set the Channel Switch Mode field 1152 to either 0 or 1 on transmission. If a STA in a BSS receives a Channel Switch Mode field that has the value 1, it shall not transmit any more frames to STAs in the BSS until the scheduled channel switch occurs. A Channel Switch Mode equal to 0 does not impose any requirement on the STA that receives the wakeup channel switch frame 1100.

The New Operating Class field 1153 is set to the number of the operating class after the channel switch.

The New Channel Number field 1154 is set to the number of the channel to which the STA is moving.

The Channel Switch Count field 1155 either is set to the time period until the STA sending the wakeup channel switch frame 1100 switches to the new channel or is set to 0. A value of 1 indicates that the switch occurs immediately before the next TBTT. A value of 0 indicates that the switch occurs at any time after the wakeup channel switch frame 1100 is transmitted.

When a STA receives the wakeup channel switch frame 1100, the STA can switch to the channel indicated by the New Channel Number field 1154 by the time indicated by the Channel Switch Count field 1155.

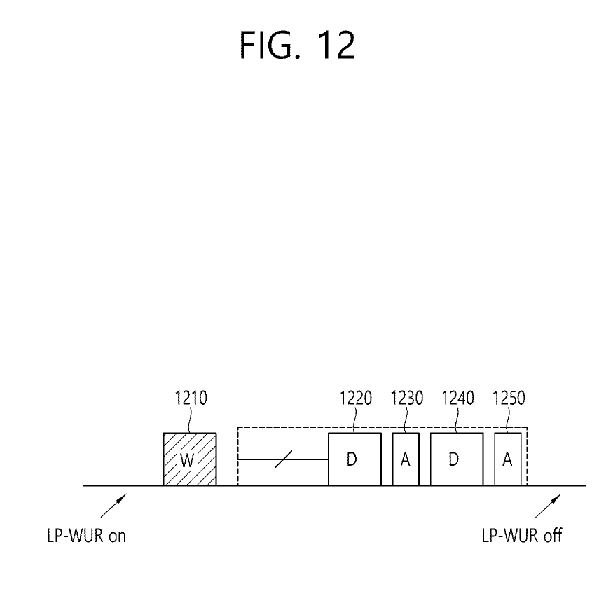

FIG. 12 shows a target wake time.

To reduce a power consumption, a target wake time may be configure between an AP and a STA. A LP-WUR module wakes up only during the target wake time. This means that a wakeup PPDU can be received during the target wake time.

At a first wake time, the STA wakes up its LP-WUS module and receives a wakeup PPDU 1210. If the wakeup PPDU 1120 is destined to the STA, the STA wakes up its 802.11 module, receives data frames 1220 and 1240, and sends ACK frames 1230 and 1250.

If a second wake time, the STA does not receive any wakeup PPDU. The STA can enter a sleep mode after the second wake time lapses.

If an AP does not send any wakeup PPDU to a STA for a long time, the AP and the STA may not be not synchronized. A reception error occurs since the wakeup time of the STA is mismatched with the transmission time of the wakeup PPDU.

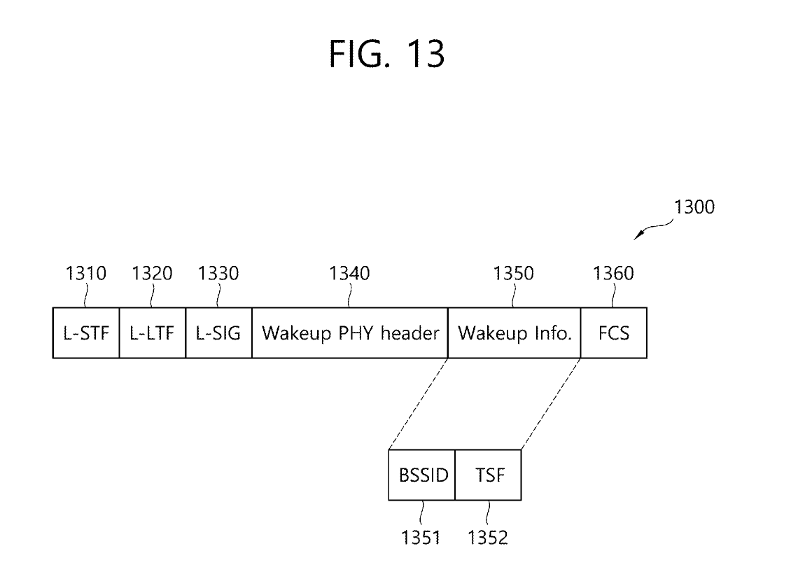

FIG. 13 shows a format of a wakeup sync frame. A wakeup sync frame 1300 is used to synchronize the AP and the STA using a target wake time. The wakeup sync frame 1300 is sent periodically or is sent during a target wake time.

L-STF 1310, L-LTF 1320, L-SIG 1330, a wakeup PHY header 1340 and FCS 1360 are described in L-STF 310, L-LTF 320, L-SIG 330 and the a wakeup PHY header 340 and the FCS 360 of FIG. 3.

Wakeup Information 1350 includes a BSSID field 1351 and a timing synchronization function (TSF) field 1352.

The BSSID field 1351 indicates the MAC address of the AP transmitting the wakeup sync frame 1300.

The TSF field 1352 contains the 4 least significant octets of the transmitting STA's TSF timer at the time that the start of the data symbol, containing the first bit of the Timestamp, is transmitted by the PHY plus the transmitting STA's delays through its local PHY from the MAC-PHY interface to its interface with the wireless medium.

When a STA receives the wakeup sync frame 1300, the STA synchronize a TSF timer of the LP-WUR module but the 802.11 module may keep sleep. If the STA does not received the wakeup sync frame 1300, the STA wakes up the 802.11 module to receive a beacon frame.

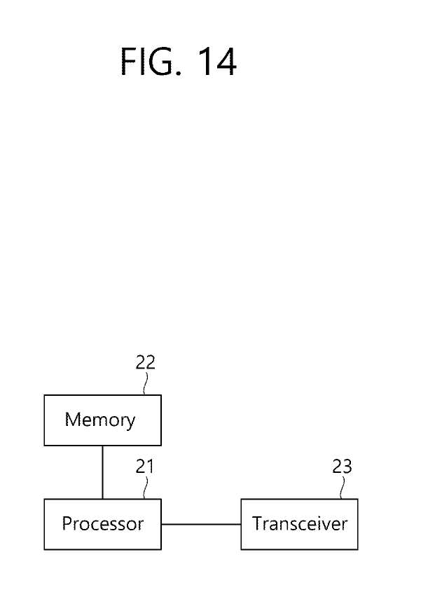

FIG. 14 shows a block diagram of a device to implement embodiments of the present invention.

A device may include a processor 21, a memory 22, and a transceiver 23. The processor 21 implements an operation of the STA/AP according to the embodiment of the present invention. The processor 21 may generate a PPDU according to an embodiment of the present invention and may instruct the transceiver 23 to receive or transmit the PPDU. The memory 22 stores instructions for the operation of the processor 21. The stored instructions may be executed by the processor 21 and may be implemented to perform the aforementioned operation of the STA. The transceiver 23 transmits and receives a radio signal. The transceiver 23 may include a first radio module (i.e. 802.11 module) and a second radio module (i.e. LP-WUR module).

The processor may include Application-Specific Integrated Circuits (ASICs), other chipsets, logic circuits, and/or data processors. The memory may include Read-Only Memory (ROM), Random Access Memory (RAM), flash memory, memory cards, storage media and/or other storage devices. The transceiver may include a baseband circuit for processing a radio signal. When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

What is claimed is:

1. A method for power saving in a wireless local area network, the method performed by a station comprising:
waking up at a start of a wakeup time;
during the wakeup time, receiving a wakeup physical layer protocol data unit (PPDU), the wakeup PPDU including a timing synchronization function (TSF) field indicating a value of a TSF timer; and
updating the TSF timer based on the TSF field,
wherein the wakeup PPDU includes a legacy-Short Training field (L-STF), a legacy-Long Training field (L-LTF) 320, a legacy-SIGNAL field (L-SIG), a wakeup physical (PHY) header and wakeup information, and
wherein the wakeup PHY header includes a sync field and a receiver ID field, the sync field indicating a start of the wakeup PHY header, the receiver ID field indicating the station to receive the wakeup PPDU.

2. The method of claim 1, wherein the sync field includes a plurality of idle symbols.

3. The method of claim 1, wherein the TSF field is included in the wakeup information.

4. The method of claim 3, wherein the wakeup information further includes a basic service set identifier (BSSID) field identifying an access point transmitting the wakeup PPDU.

5. The method of claim 4, wherein the wakeup information further includes a check beacon field indicating whether a content of a beacon frame is updated.

6. The method of claim 1, wherein the receiver ID field includes a group subfield and an address subfield, the group subfield indicating whether the wakeup PPDU is destined to a single station or a group of stations, the address subfield identifying the station.

7. The method of claim 1, further comprising:
transmitting a response frame in response to the wakeup frame,
wherein the response frame is transmitted via a first radio module of the station and the wakeup PPDU is received via a second radio module of the station.

8. The method of claim 7, wherein the first radio module is waked up after the wakeup PPDU is received.

9. A device for power saving in a wireless local area network, the device comprising:
a transceiver configured to receive and transmit radio signals; and
a processor coupled with the transceiver and configured to:
wake up at a start of a wakeup time;
during the wakeup time, control the transceiver to receive a wakeup physical layer protocol data unit (PPDU), the wakeup PPDU including a timing synchronization function (TSF) field indicating a value of a TSF timer; and
update the TSF timer based on the TSF field,
wherein the wakeup PPDU includes a legacy-Short Training field (L-STF), a legacy-Long Training field (L-LTF) 320, a legacy-SIGNAL field (L-SIG), a wakeup physical (PHY) header and wakeup information, and
wherein the wakeup PHY header includes a sync field and a receiver ID field, the sync field indicating a start of the wakeup PHY header, the receiver ID field indicating the station to receive the wakeup PPDU.

10. The device of claim 9, wherein the sync field includes a plurality of idle symbols.

11. The device of claim 9, wherein the TSF field is included in the wakeup information.

12. The device of claim 11, wherein the wakeup information further includes a basic service set identifier (BSSID) field identifying an access point transmitting the wakeup PPDU.

13. The device of claim 12, wherein the wakeup information further includes a check beacon field indicating whether a content of a beacon frame is updated.

14. The device of claim 9, wherein the receiver ID field includes a group subfield and an address subfield, the group subfield indicating whether the wakeup PPDU is destined to a single station or a group of stations, the address subfield identifying the station.

15. The device of claim 9, wherein the transceiver includes a first radio module and a second radio module.
